(19) United States
(12) Patent Application Publication
(10) Pub. No.: US 2025/0296808 A1
(43) Pub. Date: Sep. 25, 2025

(54) ARRANGEMENT AND METHOD FOR PROVIDING A POWER RESET TO A DEVICE OF AN ELEVATOR SYSTEM, AND ELEVATOR SYSTEM

(71) Applicant: KONE Corporation, Helsinki (FI)

(72) Inventors: Mika BELOV, Helsinki (FI); Dario RAVARRO, Singapore (SG)

(73) Assignee: KONE Corporation, Helsinki (FI)

(21) Appl. No.: 19/232,101

(22) Filed: Jun. 9, 2025

Related U.S. Application Data
(63) Continuation of application No. PCT/FI2023/050005, filed on Jan. 3, 2023.

(51) Int. Cl. B66B 5/02; G06F 1/24

(52) U.S. Cl. CPC B66B 5/021; G06F 1/24

(57) ABSTRACT

An arrangement for providing a power reset to a device of an elevator system, and an elevator system. The arrangement includes a power reset unit having a power reset device arranged to interrupt and connect electric power to the device, and a wireless communication device arranged to control the power reset device for interrupting and connecting electric power, and configured to be wirelessly connected by a user device by using a wireless communication technology and to receive a power reset signal from the user device. The power reset unit is integrated into or arranged in contact with the device, or connected electrically between the device and the electric power supply line.

### FIELD OF THE INVENTION

The present invention relates in general to elevator systems and associated devices. In particular, however, not exclusively, the present invention concerns arrangements and methods for providing a power reset to a device of an elevator system.

### BACKGROUND

Devices, or component(s) thereof, of elevator systems, such as Destination Guidance Displays (DGD) or Media screens or the like are more and more often integrated to external systems, such as turnstile gates or lobby area walls and/or supports. Such devices may get their electric power supply via the external system and/or electric power supply thereof. Typically, the device has a communication connection with a device or component that is also physically associated with the elevator system, such as a control unit being arranged into a control or machine room of the elevator system.

In the aforesaid solutions, it can become relatively challenging for the elevator system owner or operator to reach this kind of device that is integrated to the external system. For example, the owner or the operator of the elevator system might desire to get access to the electric power supply of the external system, e.g. to initiate power reset cycle, without removing any covers/panels protecting the electric circuits of the external system.

In many cases, integration level of the external system relative to the elevator system may be such that there are no remote control means to reset only one of the integrated devices of the external system, or particularly just the elevator device integrated therein. Even if there could be such arrangement for remotely control the device, the case may also be that the device is not any more reachable through any data communication chain (e.g. the elevator device is in some permanent error state) to initiate controlled remote reset cycle.

Furthermore, if the external system, like a turnstile gate to where the device is integrated to, is delivered by some other party than the manufacturer or provider of the elevator system, such as a third party vendor, there become a need to also involve a maintenance person of the other party to perform the power reset task. Thus, there is a need to developed solutions for enabling operating such elevator devices more easily.

### SUMMARY

An objective of the present invention is to provide an arrangement for providing a power reset to a device of an elevator system, an elevator system, and a method for providing a power reset to a device of an elevator system. Another objective of the present invention is that the arrangement, the elevator system, and the method enable power reset to be made to a device comprised in the elevator system, but which is installed in contact or even as integrated into an external system relative to the elevator system.

The objectives of the invention are reached by an arrangement for providing a power reset to a device of an elevator system, an elevator system, and a method for providing a power reset to a device of an elevator system as defined by the respective independent claims.

According to a first aspect, an arrangement for providing a power reset to a device of an elevator system is provided. The device is arranged in contact with or integrated into an external system that is external relative to the elevator system, and in communication connection with an elevator controller of the elevator system and supplied with electric power by an electric power supply line of the external system, that is a first electric power supply line. The arrangement comprises a power reset unit. The power reset unit comprises a power reset device arranged to interrupt and connect electric power to the device, and a wireless communication device arranged to control the power reset device for interrupting and connecting electric power, and configured to be wirelessly connected by a user device by using a wireless communication technology and to receive a power reset signal from the user device. Further, the power reset unit is integrated into or arranged in contact with the device, or connected electrically between the device and the electric power supply line.

Thus, the device, even if being a functionally part of the elevator system, has been arranged or is to be arranged in connection to or even integrated into an external system, and comprises, at least in some cases, only a communication connection with other part or device of the elevator system. The communication connection may be wireless or wired.

In various embodiments, the elevator system may be supplied with electric power via another separate electric power supply line, that is a second electric power supply line. Optionally, the first electric power supply line connected to the device is uncontrollable by the elevator system. Thus, the elevator system may not be capable of controlling the power supply of the device in anyway.

Alternatively or in addition, the first electric power supply line may extend via a component of the external system.

Furthermore, the power reset device may be a switch, a contactor, a relay, and/or a breaker, or the like. In a particularly advantageous embodiment the power reset device may be a relay via which electrical power is arranged to be supplied to the device.

The wireless communication device may be based on a short-range communication technology. The short-range communication technology may be one in the group consisting of: BlueTooth, Near-field communication, Near-field magnetic induction. Optionally, the operating range of the short-range communication technology is at most 20 meters, preferably at most 10 meters, or even just one meter or less.

In some embodiments, the wireless communication device may comprise at least a microphone, and wireless communication of the wireless communication device is based on audio.

In some other embodiments, additionally or alternatively, the wireless communication device may comprise at least a light sensor, wherein wireless communication of the wireless communication device is based on visible light, ultraviolet, and/or infrared, such as light fidelity technology.

In various embodiments, the power reset may, preferably, include interrupting electrical power to the device, and subsequently connecting electrical power back to the device.

Regarding the device, the device may comprise a display screen, for instance.

The external system may be or include a gate comprising a frame portion and a movable barrier element, such as a door or a bar, arranged to the frame portion. According to an example, the device is a display screen which may be integrated into the frame portion. Thus, the display screen may be inputted with data from the elevator but may be powered by the electric power supply of the gate, for instance.

In some embodiments, the display screen may be mounted to a wall or other structure of the external system.

According to a second aspect, an elevator system is provided. The elevator system comprises at least one elevator car movable in at least one elevator shaft, an elevator controller for controlling the operation of the elevator system including controlling of the movement of the at least one elevator car, a device arranged in contact with or integrated into an external system that is external relative to the elevator system. The device is in communication connection with the elevator controller and supplied with electric power by an electric power supply line of the external system, that is the first electric power supply line. The elevator system further comprises an arrangement in accordance with the first aspect, some of its embodiments being described hereinbefore.

According to a third aspect, a method for providing a power reset to a device of an elevator system is provided. The method comprises arranging a user device into a proximity, such as at most 10 metres, of the power reset unit, and providing the power reset signal to the power reset unit by the user device via a wireless communication connection between the power reset unit and the user device.

In some embodiments, the method may comprise providing, by the user device, an elevator system specific and/or an elevator device specific authentication key to the power reset unit, and verifying that the authentication key is a correct key before performing the power reset.

Still further, the method may comprise creating, in the power reset unit, a new authentication key upon performing or after having performed the power reset. The new authentication key may then be transmitted to the elevator controller or other devices of the elevator system.

The present invention provides an arrangement for providing a power reset to a device of an elevator system, an elevator system, and a method for providing a power reset to a device of an elevator system. The present invention provides advantages over known solutions in that the elevator system operator can easily perform the power reset to the device even if the device is hard to reach due to being installed closely in contact or even integrated into an external system.

Various other advantages will become clear to a skilled person based on the following detailed description.

The expression “a plurality of” may refer to any positive integer starting from two (2), that is, being two, at least two, three, at least three, etc.

The terms “first”, “second” and so on are herein used to distinguish one element from another element, and not to specially prioritize or order them, if not otherwise explicitly stated.

The exemplary embodiments of the present invention presented herein are not to be interpreted to pose limitations to the applicability of the appended claims. The verb “to comprise” is used herein as an open limitation that does not exclude the existence of also unrecited features. The features recited in the appended claims are mutually freely combinable unless otherwise explicitly stated.

The novel features which are considered as characteristic of the present invention are set forth in particular in the appended claims. The present invention itself, however, both as to its construction and its method of operation, together with additional objectives and advantages thereof, will be best understood from the following description of specific embodiments when read in connection with the accompanying drawings.

### BRIEF DESCRIPTION OF FIGURES

Some embodiments of the invention are illustrated by way of example, and not by way of limitation, in the figures of the accompanying drawings.

FIGS. 1A-1C illustrate schematically arrangements for providing a power reset to a device of an elevator system.

FIGS. 2A and 2B illustrate schematically elevator systems, each one including an arrangement for providing a power reset to a device of the elevator system.

FIGS. 3A and 3B illustrate schematically elevator systems, each one including an arrangement for providing a power reset to a device of the elevator system.

FIG. 4 shows a flow diagram of a method for providing a power reset to a device of the elevator system.

### DETAILED DESCRIPTION OF SOME EMBODIMENTS

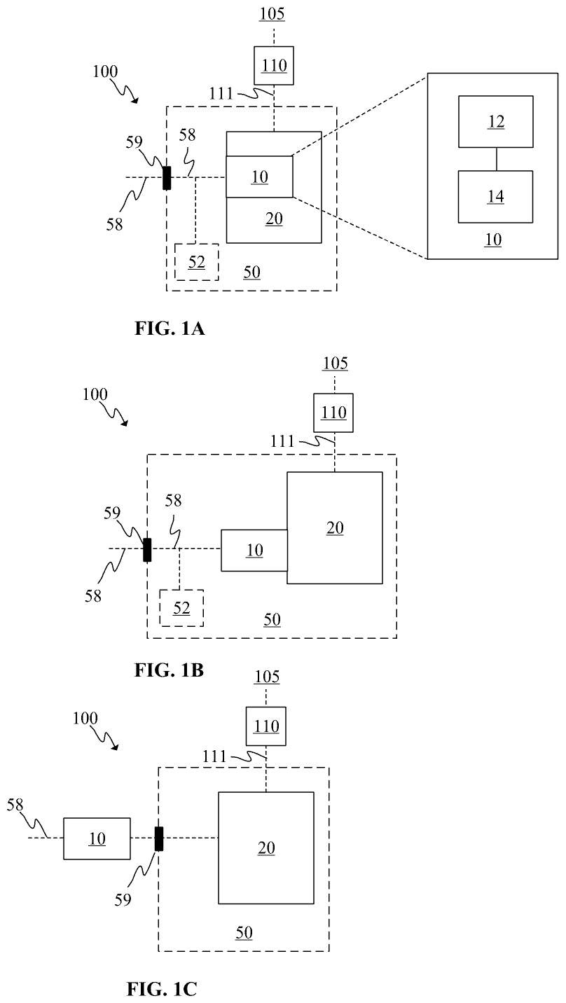

FIGS. 1A-1C illustrate schematically arrangements 100 for providing a power reset to a device 20 of an elevator system. In the arrangements 100, the device 20 is arranged in contact with or integrated into an external system 50 that is external relative to the elevator system. In addition, the device 20 is arranged to be at least in communication connection 111 with an elevator controller 110 of the elevator system 105 and to be supplied with electric power by an electric power supply line 58 of the external system 50. Thus, the elevator system 105 may be supplied with electric power via another separate electric power supply line (not shown). Furthermore, the electric power supply line 58 connected to the device 20 may be uncontrollable by the elevator system 105, that is, at least in other means than with a power reset unit 10 as described herein.

FIG. 1A illustrates that the arrangement 100 comprises a power reset unit 10. FIG. 1A also shows on the right an example of the power reset unit 10 as an enlarged view. The power reset unit 10 comprises a power reset device 12, such as a switch, a contactor, a relay, and/or a breaker, or the like, arranged to interrupt and connect electric power to the device 20. The power reset unit 10 also comprises a wireless communication device 14 arranged to control the power reset device 12 for interrupting and connecting electric power, and configured to be wirelessly connected by a user device (not shown) by using a wireless communication technology and to receive a power reset signal from the user device (not shown). The power reset unit 10 of FIG. 1A is integrated into the device 20. This may mean, for example, that the power reset unit 10 is attached on a (back) side of the device 20 and then provided interconnection therebetween, or connected to a connection interface or port (for example, just like devices or cards to motherboard of a personal computer) inside the device 20, such as at least inside the outer housing of the device 20. In the aforesaid cases, the power reset unit 10 is inside the external system 50, such as within or inside a volume defined by the outer housing thereof. Thus, the electric power supply line 58 may optionally extend via a component, such as the housing, of the external system 50.

FIG. 1B illustrates that the arrangement 100 comprises a power reset unit 10. The power reset unit 10 comprises a power reset device 12, such as a switch, a contactor, a relay, and/or a breaker, or the like, arranged to interrupt and connect electric power to the device 20. The power reset unit 10 also comprises a wireless communication device 14 arranged to control the power reset device 12 for interrupting and connecting electric power, and configured to be wirelessly connected by a user device (not shown) by using a wireless communication technology and to receive a power reset signal from the user device (not shown). The power reset unit 10 of FIG. 1B is arranged in contact with the device 20, such as being attached to a (back) side of the device 20.

Alternatively, the power reset unit 10 may be at least electrically connected between the device 20 and the electric power supply line 58 of the external system 50, and provided inside the external system 50, such as within or inside a volume defined by the outer housing thereof. Thus, the electric power supply line 58 may optionally extend via a component, such as the housing, of the external system 50. Alternatively, the power reset unit 10 may be arranged into a space or volume defined by the external system 50 and the device 20 therebetween. The power reset unit 10 may thus be arranged to space or volume which is at least partly covered.

FIG. 1C illustrates that the arrangement 100 comprises a power reset unit 10. The power reset unit 10 comprises a power reset device 12, such as a switch, a contactor, a relay, and/or a breaker, or the like, arranged to interrupt and connect electric power to the device 20. The power reset unit 10 also comprises a wireless communication device 14 arranged to control the power reset device 12 for interrupting and connecting electric power, and configured to be wirelessly connected by a user device (not shown) by using a wireless communication technology and to receive a power reset signal from the user device (not shown). The power reset unit 10 of FIG. 1C is connected electrically between the device 20 and the electric power supply line 58 of the external system 50. In this case, the power reset unit 10 can be physically spaced apart or separate relative to the device 20, optionally also spaced apart and outside relative to the external system 50. In some embodiments, however, the power reset unit 10 may be arranged in contact with the outer housing or structure of the external system 50, that is outside of the outer housing or the structure, when physically spaced apart or separate relative to the device 20.

Furthermore, there may or may not be other devices 52 of the external system 50 being supplied by the electric power supply line 58. In some embodiments, there may be a dedicated power supply line for just the device 20. Alternatively, the power reset unit 10 may be arranged provide power reset simultaneously to other device(s) 52 when performing power reset to the device 20 due to the fact that the power reset unit 10 is arranged to the same electric power supply line 58.

FIGS. 1A-1C also show that the electric power supply line 58 may be connected to a power input port 59 which is further connected to the device 20 via the power reset unit 10. The power input port 59 can also be connected to other devices 52 of the external system 50. Alternatively, the electric power supply line 58, such as, as a cable or conductor, may extend, from outside the external system 50, directly to the device 20 via the power reset unit 10 without any ports or connection portions therebetween. Thus, the electric power supply line 58, or at least portion thereof, may extend inside the external system 50, such as the outer housing thereof, to the power reset unit 10 from which it can continue to the device 20.

In various embodiments, the wireless communication device 14 may, preferably, be based on a short-range communication technology, such as having an operating range of at most 20 meters, preferably at most 10 meters, or even just one meter or less, for transmitting and/or receiving the power reset signal. The short-range communication technology may, for example, be based on BlueTooth (BT), Near-field communication (NFC), or Near-field magnetic induction (NFMI).

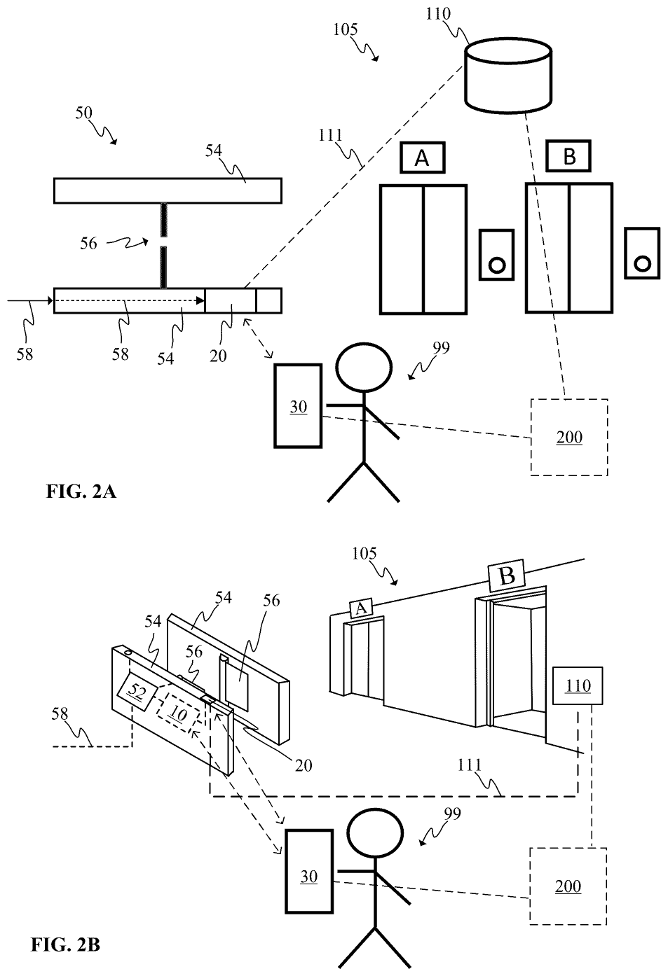

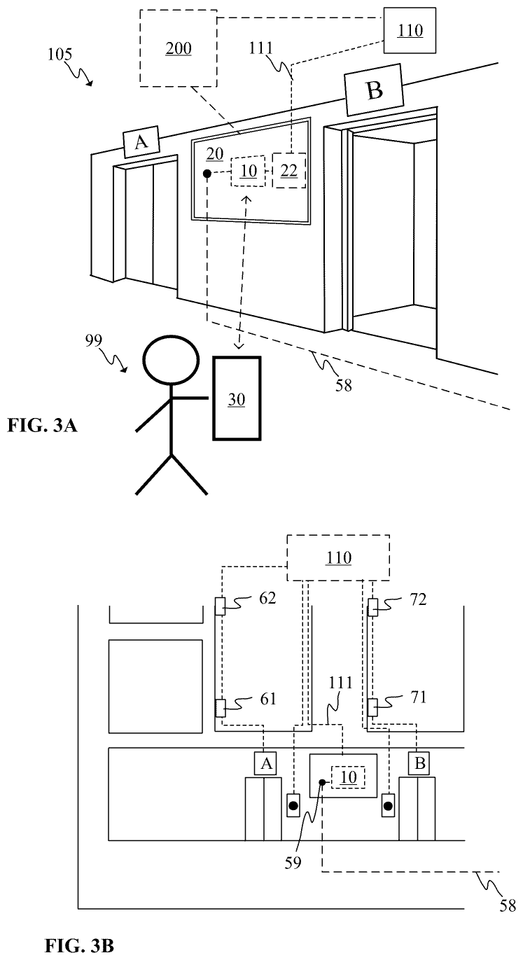

According to an embodiment, the wireless communication device 14 may comprise at least a microphone, and wireless communication of the wireless communication device 14 is thus based on audio, for example, a speaker of a user device (30; see FIGS. 2A-3B) sending audio waves and the microphone receiving them and detecting the power reset signal therefrom.

Alternatively or in addition, the wireless communication device 14 may comprise at least a light sensor, wherein wireless communication of the wireless communication device 14 may be based on visible light, ultraviolet, and/or infrared, such as light fidelity technology. Transmitting the power reset signal may thus be based on aforementioned signal types.

In various embodiments, the power reset unit 10 is configured to utilize an elevator system specific and/or elevator device specific authentication key for enabling providing the power reset to the device 20 by the user device 30. Thus, the user device 30 must provide a correct authentication key, either regarding the device 20 or the power reset unit 10, and/or of the elevator system 105, in order to be able to provide the power reset.

If the authentication key doesn't match, the power reset is not performed. The authentication key may have been created, for example, during commissioning of the elevator system 105.

FIGS. 2A and 2B illustrate schematically elevator systems 105, each one including an arrangement 100 for providing a power reset to a device 20 of the elevator system 105. Some components of the elevator system 105 are shown on the right, such as two elevator shafts A and B. A person skilled in the art realizes that the elevator system 105 comprises also other components and devices not visible in the figures. For example, there may be one or several elevator cars movable in each of the elevator shafts A and B. There may also be some hoisting or driving means, such as including electric motor(s) and sheave(s), for moving the elevator car(s) in the shafts. In some embodiments, there can only be one elevator shaft and one elevator car, however, there may be more than two shafts with an elevator car or several cars movable therein. As stated hereinbefore, there may be an elevator controller 110 for controlling the operation of the elevator system, preferably, including controlling of the movement of the at least one elevator car.

FIGS. 2A and 2B further illustrates a user 99, such as a maintenance person, holding a user device 30 which is, preferably, configured to utilize a wireless communication technology of the user device to transmit a power reset signal to the arrangement 100, particularly to the power reset unit 10. The wireless communication technology may, preferably, be functionally compatible with the wireless communication device 14 of the power reset unit 10. For example, both of them may use BlueTooth communication technology just to name one example.

Furthermore, the elevator system 105 may comprise an external system 50 which is, in case of FIGS. 2A and 2B, a gate, such as a turnstile gate. The turnstile gate comprises a frame portion or portions 54 and a movable barrier element(s) 56, such as a door or a bar, arranged to the frame portion or portions 54. There may be a device 20 of the elevator system 105, such as a display screen, being integrated into or at least arranged in contact with the turnstile gate, as illustrated in FIGS. 2A and 2B. The display screen may be integrated into the frame portion 54. As can be realized, the display screen may be powered by the electric power supply line 58 of the turnstile gate. Thus, in various embodiments, the power reset unit 10 may be arranged into the turnstile gate and in connection to the electric power supply line 58 in order to enable power reset to be provided to the display screen (that is, the device 20). As described hereinbefore, the power reset includes interrupting electrical power to the device 20, and subsequently connecting electrical power back to the device 20, thereby providing the power reset.

In FIGS. 2A and 2B, the power reset unit 10 has been shown to reside inside the frame 54 of the turnstile gate. The power reset unit 10 could be arranged as described in connection with any of FIGS. 1A-IC.

In some embodiments, the elevator system 105 may also comprise a server system 200. The server system 200 may be a local server system at the site of the elevator system 105 or an external server system, such as a cloud computing system. There may be a communication connection arranged between the elevator controller 110 and the server system 200. Alternatively or in addition, the user device 30 may be arranged in communication connection with the server system 200. The communication connection with the server system 200 may, preferable, be based on a different technology than the connection to the power reset unit 10. The connection may be, for example, a mobile phone network connection, such as 3G, 4G, 5G, GSM, UMTS, etc., or it may be based on wireless local area network connection, such as Wi-Fi. The connection between the elevator controller 110 and the server system 200 may be wired or wireless. This description about the server system 200 and connections therefrom and thereto apply also to systems 105 in FIGS. 3A and 3B with respect to embodiments comprising the server system 200.

FIGS. 3A and 3B illustrate schematically elevator systems 105, each one including an arrangement for providing a power reset to a device 20 of the elevator system 105. The elevator system 105 may comprise an external system 50 which is, in case of FIGS. 3A and 3B, a display screen is mounted to a wall, such as lobby area wall, or other structure of the external system 50, the external system 50 herein being portion of the building. In this particular example, the power reset unit 10 is arranged either integrated into the display screen or arranged in contact with the display screen and residing in a space or volume between the display screen and the wall. Also, the electric power supply line 58 runs inside the wall and has an outlet residing behind the display screen. Thus, providing a power reset would require removing the display screen from the wall and even detaching conductors from the displays screen. The device 20 may comprise own device controller 22 which can include processor and memory to control operation of the device 20. There may also be a communication unit.

In some embodiments, the power reset unit 10 may be arranged spaced apart from the display screen, such as into a control panel or the like, as long as the electric power supply line 58 runs via it.

FIG. 3B illustrates schematically that the elevator system 105 may comprise various further devices also, such as those in the elevator shaft, mainly floor zone sensors 61-72 or the like. Furthermore, there can be elevator call buttons arranged next to the landing floor doors. All of these may be connected to the elevator controller 110 and, preferably, powered by the electric power supply line of the elevator system 105. As can be seen in FIG. 3B, the display screen in arranged in communication connection 111 with the elevator controller 110, however, is supplied with electric power from the electric power supply line 58 via the power reset unit 10 of the arrangement 100.

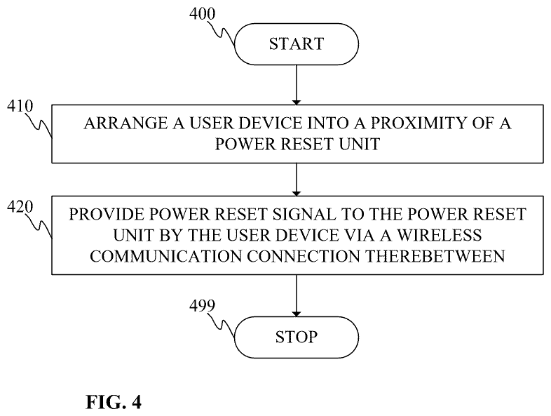

FIG. 4 shows a flow diagram of a method for providing a power reset to a device of the elevator system 105.

Item or method step 400 refers to a start-up phase of the method. Suitable equipment and components are obtained and systems assembled and configured for operation.

Item or method step 410 refers to arranging a user device 30 into a proximity of the power reset unit 10. For example, the user 99, such as the maintenance person, may bring the user device 30, for example, a mobile terminal, into the proximity.

Item or method step 420 refers to providing the power reset signal to the power reset unit 10 by the user device 30 via a wireless communication connection between the unit 10 and the user device 30. This occurs when the user device 30 is in the proximity so as to enable establishing the communication connection. Thus the user 99 doesn't have to open any panel or the like to be able to provide the power reset.

Method execution may be stopped at step 499.

In various embodiments, the method may further comprise utilizing an elevator system specific and/or elevator device specific authentication key to be able to provide the power reset to the device 20 by the user device 30. Thus, the user device 30 must provide a correct authentication key, either regarding the device 20 or the power reset unit 10, and/or of the elevator system 105, in order to be able to provide the power reset. If the authentication key doesn't match, the power reset is not performed. The authentication key may have been created, for example, during commissioning of the elevator system 105.

Furthermore, the method may comprise creating, in the power reset unit 10, a new authentication key upon performing or after having performed the power reset. The new authentication key may afterwards be communicated to the elevator controller 110 and/or to the server system 200. Thus, the user device 30 may be required to obtain the new authentication key before being able to initiate new power reset. Alternatively, the new authentication key may be loaded from another elevator device of the elevator system 105. Thus, in other words, the new authentication key may be created in response to the power reset.

1. An arrangement for providing a power reset to a device of an elevator system, wherein the device is arranged in contact with or integrated into an external system that is external relative to the elevator system, and in communication connection with an elevator controller of the elevator system and supplied with electric power by an electric power supply line of the external system, the arrangement comprising:
a power reset unit comprising:
a power reset device arranged to interrupt and connect electric power to the device, and
a wireless communication device arranged to control the power reset device for interrupting and connecting electric power, and configured to be wirelessly connected by a user device by using a wireless communication technology and to receive a power reset signal from the user device,
wherein the power reset unit is integrated into or arranged in contact with the device, or connected electrically between the device and the electric power supply line.

2. The arrangement of claim 1, wherein the elevator system is supplied with electric power via another separate electric power supply line, optionally the electric power supply line connected to the device being uncontrollable by the elevator system.

3. The arrangement of claim 1, wherein the electric power supply line extends via a component of the external system.

4. The arrangement of claim 1, wherein the power reset device is a relay via which electrical power is arranged to be supplied to the device.

5. The arrangement of claim 1, wherein the wireless communication device is based on a short-range communication technology, such as having an operating range of at most 20 meters, preferably at most 10 meters, or even just one meter or less, in the group consisting of: BlueTooth (BT), Near-field communication (NFC), Near-field magnetic induction (NFMI).

6. The arrangement of claim 1, wherein the wireless communication device comprises at least a microphone, and wireless communication of the wireless communication device is based on audio.

7. The arrangement of claim 1, wherein the wireless communication device comprises at least a light sensor, wherein wireless communication of the wireless communication device is based on visible light, ultraviolet, and/or infrared, such as light fidelity technology.

8. The arrangement of claim 1, wherein the power reset includes interrupting electrical power to the device, and subsequently connecting electrical power back to the device.

9. The arrangement of claim 1, wherein the device comprises a display screen.

10. The arrangement of claim 9, wherein the external system is a gate comprising a frame portion and a movable barrier element, such as a door or a bar, arranged to the frame portion.

11. The arrangement of claim 10, wherein the display screen is integrated into the frame portion.

12. The arrangement of claim 9, wherein the display screen is mounted to a wall or other structure of the external system.

13. An elevator system comprising:
at least one elevator car movable in at least one elevator shaft,
an elevator controller for controlling the operation of the elevator system including controlling of the movement of the at least one elevator car,
a device arranged in contact with or integrated into an external system that is external relative to the elevator system, the device being in communication connection with the elevator controller and supplied with electric power by an electric power supply line of the external system, and
an arrangement of claim 1 for providing a power reset to the device.

14. A method for providing a power reset to a device of an elevator system of claim 13, the method comprising:
arranging a user device into a proximity, such as at most 10 metres, of the power reset unit, and
providing the power reset signal to the power reset unit by the user device via a wireless communication connection between the unit and the user device.

15. The method of claim 14, comprising providing, by the user device, an elevator system specific and/or an elevator device specific authentication key to the power reset unit, and verifying that the authentication key is a correct key before performing the power reset.

16. The arrangement of claim 2, wherein the electric power supply line extends via a component of the external system.

17. The arrangement of claim 2, wherein the power reset device is a relay via which electrical power is arranged to be supplied to the device.

18. The arrangement of claim 3, wherein the power reset device is a relay via which electrical power is arranged to be supplied to the device.

19. The arrangement of claim 2, wherein the wireless communication device is based on a short-range communication technology, such as having an operating range of at most 20 meters, preferably at most 10 meters, or even just one meter or less, in the group consisting of: BlueTooth (BT), Near-field communication (NFC), Near-field magnetic induction (NFMI).

20. The arrangement of claim 3, wherein the wireless communication device is based on a short-range communication technology, such as having an operating range of at most 20 meters, preferably at most 10 meters, or even just one meter or less, in the group consisting of: BlueTooth (BT), Near-field communication (NFC), Near-field magnetic induction (NFMI).
